(19) United States
(12) Patent Application Publication
(10) Pub. No.: US 2020/0352141 A1
(43) Pub. Date: Nov. 12, 2020

(54) Portable Coop

(71) Applicant: Zachary Cheston Colten, Nederland, TX (US)

(72) Inventor: Zachary Cheston Colten, Nederland, TX (US)

(21) Appl. No.: 16/407,090

(22) Filed: May 8, 2019

(51) Int. Cl. A01K 31/18; A01K 31/16; A01K 31/10; A01K 39/02; A01K 39/014

(52) U.S. Cl. CPC A01K 31/18; A01K 31/16; A01K 39/014; A01K 39/0213; A01K 31/10

(57) ABSTRACT

Provided herein is a portable coop that helps maintain hygiene within the living space. The portable coop has a lockable first entry door and a lockable second entry on either end of the coop which when opened respectively provide access for easy cleaning and easy access into and out of the coop for the poultry. The inside of the coop contains nesting box(es), feeder troughs and perch(es). Water and food reservoirs attached on the outer surface but open to the inside of the coop. Poultry can access water and food when needed from within the living space. The reservoirs keep the food and water free from mold and other infectious agents thereby helping maintain a heathy flock.

### BACKGROUND OF THE INVENTION

### Field of the Invention

The present invention is in the field of animal husbandry, particularly, poultry management. More specifically, the present invention is directed to a portable coop.

### Description of the Related Art

Poultry coops are popular and the most viable solution for poultry and egg farming. Poultry coops (coop, coop) provide farmers a manageable means for keeping their poultry secure from predators and weather, while at the same time making it easy to harvest eggs.

Coops typically comprise a fenced enclosure for the birds to freely move about, rest and feed, a smaller indoor area where they can sleep and nest and a hard or padded surface for the floor. Feed is usually placed in open containers or scattered on the ground within the enclosure. Food delivered in this manner causes waste leading to increased costs. Moreover, open food can get moist from rain leading to mold or get contaminated with bird droppings. Both these cause disease and infection in livestock, leading to poor quality of eggs and poultry. Providing water in open containers also increases costs due to loss from evaporation. Furthermore, typical coop design requires cleaning the enclosure at least every two weeks, which is laborious and time consuming.

There is, therefore, a need for a better designed coop that reduces maintenance and costs. The present invention fulfills this longstanding need and desire in the art.

### SUMMARY OF THE INVENTION

The present invention is directed to a portable coop. The portable coop comprises a frame that is secured to a floor, a first entry door attached to the floor by hinges at a front end of the frame and a second entry door that is attached to the floor by hinges at a back end of the frame. The first entry door comprises at least one nesting box access door attached by hinges on an outer surface. At least one nesting box is attached on an inner surface of the first entry door and is accessible from a front side of the first entry door through the nesting box access door. A waterer assembly and a plurality of feeder assemblies are attached to an outer surface of the frame. A plurality of feeder troughs is attached to an inner surface of the frame. At least one perch is secured at each end of the frame inner surface of the frame. The present invention is directed to a related portable coop that further comprises a lock and chain assembly on the front end of the frame and on the back end of the frame, securable across the first entry door and second entry door.

The present invention also is directed to another portable coop. The portable coop comprises a substantially semispherical frame attached to a floor and enclosing a living space for poultry. The portable coop has a first entry door attached to the floor at a front end, at least one nesting box access door disposed on an outer surface of the first entry door, a second entry door attached to the floor at a back end of the portable coop, and a lock and chain assembly disposed on each of the front end and the back end of the frame where the chain is securable across the first entry door and the second entry door. At least one nesting box is attached to the inner surface of the first entry door and is accessible through the at least one nesting box access door. A waterer assembly and a plurality of feeder assemblies are attached to an outer surface of the frame and a plurality of feeder troughs are disposed on the inner surface of the frame. At least one perch is secured at each end on the inner surface of the frame. The waterer assembly has a water reservoir and a water nipple. The water reservoir has an open top end and an open bottom end and an open bottom end in fluid connection with an inside surface of the portable coop. The water nipple is in fluid connection with the open bottom end. An end cap is removably securable to the open top end of the water reservoir. Each of the plurality of feeder assemblies has a feed reservoir and a feed receptacle. The feed reservoir has an open top end and an open bottom end that is in fluid connection with the feed receptacle on the inside surface of the portable coop. The feed receptacle is in fluid connection with the open bottom end of the feed reservoir and comprises an end open to the inside of the portable coop. End caps are each removably securable to the open top end of the feed reservoir and to the feed receptacle

Other and further aspects, features, benefits, and advantages of the present invention will be apparent from the following description of the presently preferred embodiments of the invention given for the purpose of disclosure.

### BRIEF DESCRIPTION OF THE DRAWINGS

FIG. 1 is a left side front to back perspective view of the coop showing two nesting box access doors in closed configuration on the first entry door, a water reservoir and a pair of feed reservoirs.

FIG. 2 is a left side front to back perspective view of the coop showing two nesting box access doors in an open configuration on the first entry door, a water reservoir and a pair of feed reservoirs.

FIG. 3 is a close-up view of the first entry door showing the two nesting box access doors in open configuration.

FIG. 4 is side view of the coop showing the second entry door open.

FIG. 5 is a right side back to front perspective view of the coop showing the water reservoir and the pair of feed reservoirs.

FIG. 6 is a close-up view of the back end of the coop showing a lock and chain assembly that secures the second entry door.

FIG. 7 is a back to front inside view of the living space within the housing in the coop showing feeder troughs attached to an inner surface of the frame, the perches secured across the wire mesh frame and a wire mesh floor.

FIG. 8 is a close-up view showing the feeder troughs.

FIGS. 9A-9B show the feed reservoir being filled with poultry feed. FIG. 9A shows food being stocked within the feed reservoir through an open top end. FIG. 9B shows the food within the feed receptacle accessible to poultry from within the living space.

FIGS. 10A-10B shows the water reservoir being filled with water. FIG. 10A shows the reservoir being filled with water. FIG. 10B shows a chicken using the water nipple to drink water from within the living space in the coop.

### DETAILED DESCRIPTION OF THE PRESENT INVENTION

For convenience, before further description of the present invention, certain terms employed in the specification, examples and appended claims are collected herein. These definitions should be read in light of the remainder of the disclosure and understood as by a person of skill in the art. Unless defined otherwise, all technical and scientific terms used herein have the same meaning as commonly understood by a person of ordinary skill in the art.

The articles “a” and “an” when used in conjunction with the term “comprising” in the claims and/or the specification, may refer to “one”, but it is also consistent with the meaning of “one or more”, “at least one”, and “one or more than one”. Some embodiments of the invention may consist of or consist essentially of one or more elements, components, method steps, and/or methods of the invention. It is contemplated that any composition, component or method described herein can be implemented with respect to any other composition, component or method described herein.

The term “or” in the claims refers to “and/or” unless explicitly indicated to refer to alternatives only or the alternatives are mutually exclusive, although the disclosure supports a definition that refers to only alternatives and “and/or”.

The terms “comprise” and “comprising” are used in the inclusive, open sense, meaning that additional elements may be included.

The term “including” is used herein to mean “including, but not limited to”. “Including” and “including but not limited to” are used interchangeably.

As used herein, the terms “portable coop” and “coop” are interchangeable.

In one embodiment of the present invention there is provided a portable coop, comprising a frame secured to a floor, a first entry door hingedly attached to the floor at a front end of the frame and comprising at least one nesting box access door hingedly attached on an outer surface thereof; a second entry door hingedly attached to the floor at a back end of the frame; at least one nesting box disposed on an inner surface of the first entry door, said nesting box accessible through the at least one nesting box access door; a waterer assembly attached to an outer surface of the frame; a plurality of feeder assemblies attached to the outer surface of the frame; a plurality of feeder troughs attached to an inner surface of the frame; and at least one perch secured at each end thereof to the inner surface of the frame. Further to this embodiment the portable coop comprises a lock and chain assembly disposed on the front end of the frame and on the back end of the frame, where the chain is securable across the first entry door and the second entry door.

In both embodiments the frame may have a substantially semi-spherical shape. Also the first entry door, the second entry door, the nesting box and the pair of nesting box access doors may be made of a weather-resistant wood, a weather-resistant wood composite, or a weather-resistant synthetic composite, or a combination thereof. In addition the feeder troughs may be made of a weather-resistant plastic or a weather-resistant plastic composite, a metal, or a metal alloy, or a combination thereof. Furthermore the perch may be made from weather-resistant wood, a weather-resistant wood composite, a weather-resistant synthetic composite, weather-resistant plastic, a weather-resistant plastic composite, a metal, or a metal alloy, or a combination of any of these materials. Further still a back half of the frame may be made substantially of wire mesh.

Also in both embodiments the waterer assembly may comprise a water reservoir with an open top end and an open bottom end attached to an outer surface of the frame, where the open bottom end is in fluid connection with an inside surface of the portable coop and a water nipple attached to and in fluid connection with the open bottom end of the water reservoir. Further to this embodiment the waterer assembly may comprise an end cap removably securable to the open top end of the water reservoir. In both of these embodiments the water reservoir and the water nipple may be made of a weather-resistant plastic or a weather-resistant plastic composite, a metal, or a metal alloy, or a combination thereof.

In addition in both embodiments each of the plurality of feeder assemblies comprise a feed reservoir with an open top end and an open bottom end and each attached to an outer surface of the frame, where the open bottom ends are in fluid connection with an inside of the portable coop and a feed receptacle in fluid connection with the open bottom end of the feed reservoir and comprising an end open to the inside of the portable coop. Further to this embodiment the plurality of feeder assemblies may comprise end caps each removably securable to the open top end of the feed reservoir and to the feed receptacle. In both of these embodiments the feed reservoirs, the feed receptacle and the feed receptacle may be made of a weather-resistant plastic or a weather-resistant plastic composite, a metal, or a metal alloy, or a combination thereof.

In yet another embodiment of the present invention there is provided a portable coop comprising a substantially semispherical frame attached to a floor and enclosing a living space for poultry that has a first entry door attached to the floor at a front end of the portable coop; at least one nesting box access door disposed on an outer surface of the first entry door; a second entry door attached to the floor at a back end of the portable coop; and a lock and chain assembly disposed on each of the front end and the back end of the frame, said chain securable across the first entry door and the second entry door; at least one nesting box attached to the inner surface of the first entry door and accessible through the at least one nesting box access door; a waterer assembly attached to an outer surface of the frame and comprising a water reservoir with an open top end and an open bottom end, said open bottom end in fluid connection with an inside surface of the portable coop; a water nipple in fluid connection with the open bottom end; and an end cap removably securable to the open top end of the water reservoir;

a plurality of feeder assemblies attached to an outer surface, each comprising a feed reservoir with an open top end and an open bottom end, said open bottom end in fluid connection with the inside surface of the portable coop; a feed receptacle in fluid connection with the open bottom end of the feed reservoir and comprising an end open to the inside of the portable coop; and end caps each removably securable to the open top end of the feed reservoir and to the feed receptacle; a plurality of feeder troughs disposed on the inner surface of the frame; and at least one perch secured at each end on the inner surface of the frame.

In this embodiment the frame has a substantially semi-spherical shape. Also, the frame may have a length from about 4 feet to about 12 feet and a width from about 4 feet to about 8 feet at a base attached to the floor. In addition in this embodiment the frame, the first entry door, second entry door, nesting box, nesting box access door the water reservoir, the water nipple, the feed reservoir, the feed receptacle, the feeder troughs, and the perch may each be made of the materials or combination of materials as described supra.

Provided herein is a portable coop comprising a substantially semispherical frame attached to a floor and enclosing a living space for poultry. The frame may have any shape that allows the enclosure to be installed stably on the ground. For example the frame may have a substantially semi-spherical shape. The frame may have any dimension suitable for the number and type of poultry being housed. For example, the frame may have at the base an overall length of about 8 feet to about 16 feet and an overall width from about 4 feet to about 12 feet. The frame may be constructed of any suitable weather resistant material including, but not limited to weather-resistant wood, a weather-resistant wood corn positeookopher-resistant plastic, a weather-resistant plastic composite, a metal, a metal alloy, or a combination of any of these materials. In non-limiting examples, the frame may be made of weather-resistant wood or the front half may be weather-resistant wood and the back half may be wire mesh. In another non-limiting example the floor may be made of wire mesh comprising galvanized steel or zinc-coated steel.

The portable coop may have a first entry door at one end of the coop and a second entry door at the other end of the coop. The entry doors each may be secured with a chain and lock assembly disposed on the frame such that the lock secures the chain across the outer surfaces of the entry doors to prevent them from opening.

The portable coop comprises at least one nesting box access door, for example, a pair of nesting box access doors, on the first entry door. At least one nesting box is provided that is attached to the inner surface of the first entry door and accessible through the at least one nesting box access door. The nesting box has a cavity large enough to house one bird. The nesting box access door provides access to the eggs without having to open the first entry door. The first entry door, the second entry door, the nesting box and the nesting box access doors may be constructed of any suitable weather resistant material including, but not limited to, weather-resistant wood, a weather-resistant wood composite, a weather-resistant synthetic composite, weather-resistant plastic, a weather-resistant plastic composite, a metal, a metal alloy, or a combination of any of these materials. In a non-limiting example, weather-resistant wood is utilized.

The portable coop also comprises a waterer assembly and a plurality of feeder assemblies on the outside of the frame, but fluidly connected with the inside of the coop for easy access for the poultry. The inside of the portable coop has a plurality of feeder troughs and at least one perch. The waterer assembly and the feeder assemblies have end caps covering the open ends which enables one to transport the coop without spilling the feed and water.

The waterer assembly comprises a water reservoir and water nipple for access by the poultry. The feeder assembly comprises a feed reservoir and a feed receptacle for access by the poultry. The feeder troughs are attached to an inner surface of the frame and are used for storing, for example, but not limited to, grit, calcium supplements or vitamin supplements. Each of the water reservoir, water nipple, feed reservoirs, feed receptacles and feeder troughs may made of any material including, but not limited to a weather-resistant plastic, a weather-resistant plastic composite, a metal or a metal alloy or a combination of these materials. The perch may be made from any material including, but not limited to a weather-resistant wood, a weather-resistant wood composite, a weather-resistant synthetic composite, weather-resistant plastic, a weather-resistant plastic composite, a metal, or a metal alloy, or a combination of any of these materials.

Particularly, embodiments of the present invention are better illustrated with reference to the Figure(s), however, such reference is not meant to limit the present invention in any fashion. The embodiments and variations described in detail herein are to be interpreted by the appended claims and equivalents thereof.

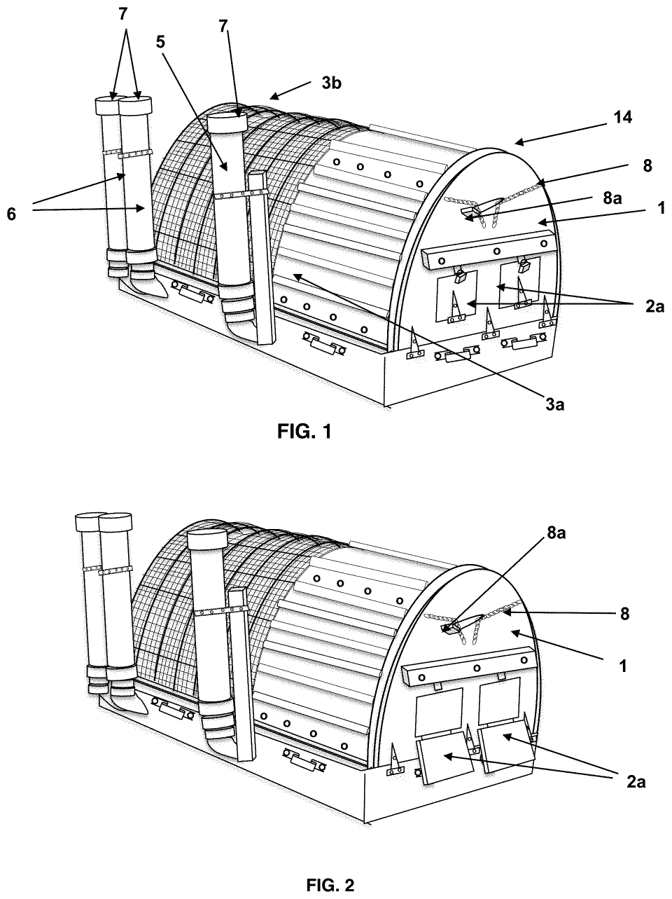

FIG. 1 is a left side front to back perspective view of the coop 14 showing a first entry door 1 attached to the frame by a pair of hinges at the bottom to raise and lower the door to close and open respectively, a pair of hinged nesting box access doors 2a in a closed configuration on the first entry door, a water reservoir 5, a pair of feed reservoirs 6, and end caps 7 disposed outside the living space on the coop. The coop comprises a corrugated portion 3a and a wire mesh portion 3b made from steel. A chain 8 and lock 8a assembly is provided to secure the first entry door from predators. Opening the first entry door provides easy access for cleaning.

With continuous reference to FIG. 1, FIG. 2 is a right-side front to back perspective view of the coop showing the chain 8 and lock 8a and pair of nesting box access doors 2a in an open configuration on the first entry door 1.

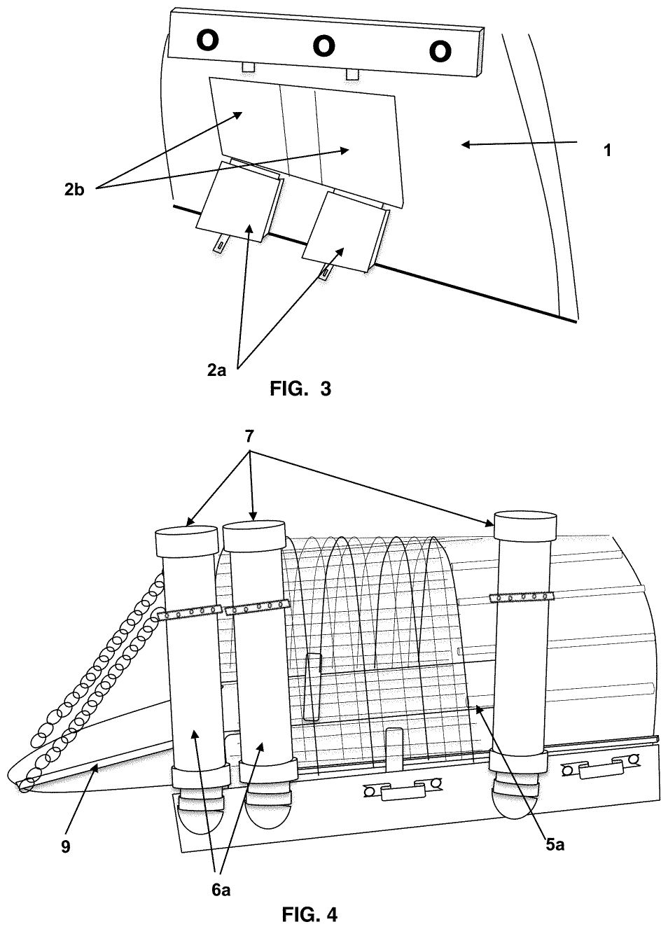

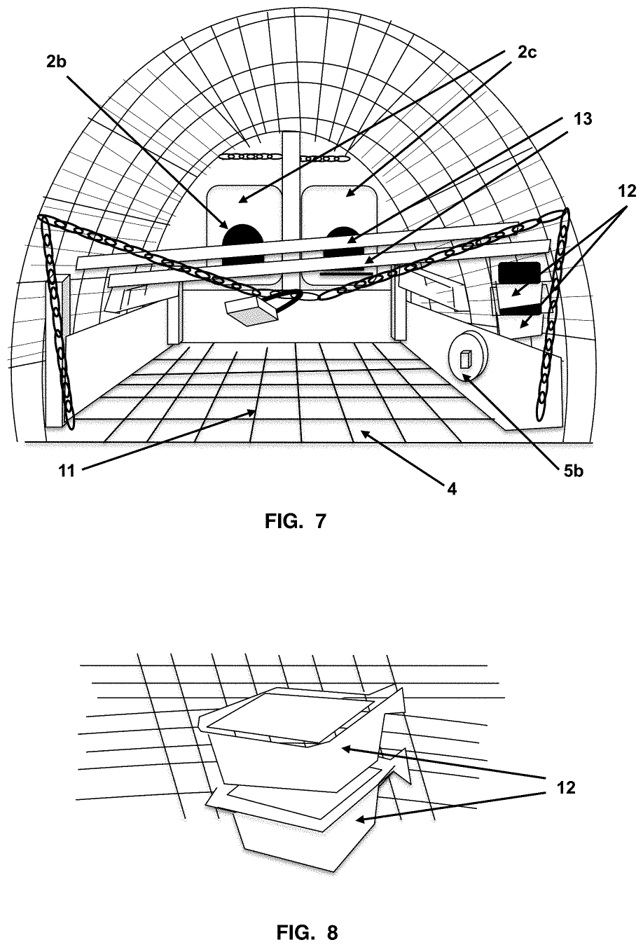

With continuous reference to FIG. 2, FIG. 3 is a close-up view of the first entry door 1 showing the two nesting box access doors 2a in open configuration and accessing a cavity 2b formed within the nesting box 2c (see FIG. 7).

FIG. 4 is side view of the coop showing the second entry door 9 in an open configuration as a ramp providing easy ingress and egress for the poultry when the coop is moved. The pair of feed reservoirs 6a and a water reservoir 5a are each shown with an end cap 7.

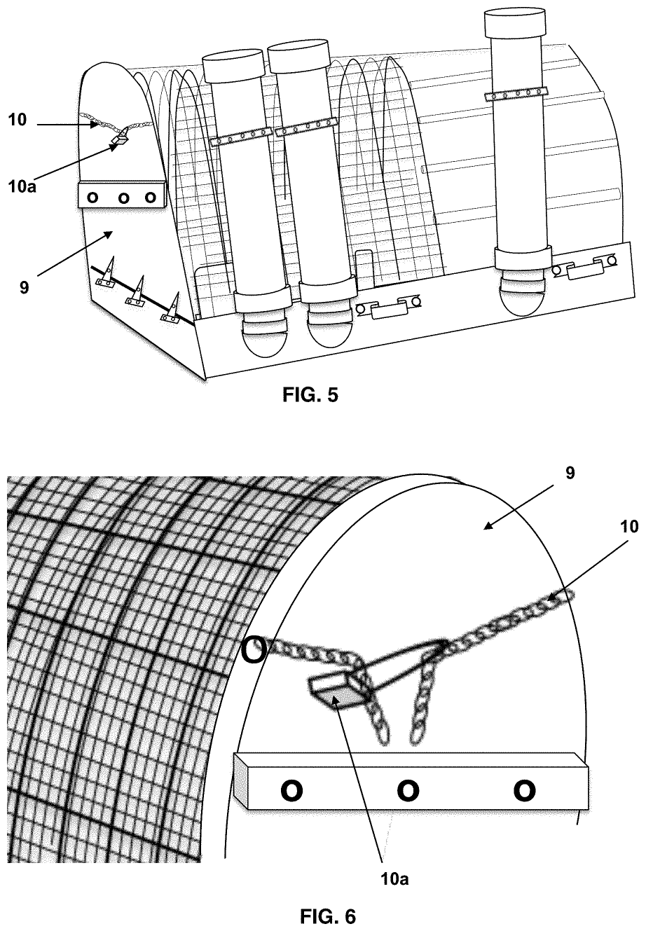

With continuous reference to FIG. 4, FIG. 5 is a right side back to front perspective view of the coop showing the second entry door 9 in a closed configuration, chain 10 and lock 10aand the water and feeder reservoirs.

With continuous reference to FIG. 5, FIG. 6 is a close-up view of the back end of the coop showing the second entry door secured with the chain 10 and lock 10a assembly.

FIG. 7 is a back to front inside view of the living space 4 within the coop showing feeder troughs 12 attached on the inner surface wire mesh of the frame, the cavity 2b comprised within the nesting box 2c, chain and lock, two perches 13 and a floor wire mesh 11 that prevents predators from digging into the enclosure from underneath the ground and also avoids bird droppings from accumulating within the living space. This is advantageous since regular cleaning is unnecessary and there is less danger of infections from the droppings.

With continuous reference to FIG. 7, FIG. 8 is a closeup of view of the feeder troughs, 12 attached on the inner surface wire mesh of the frame.

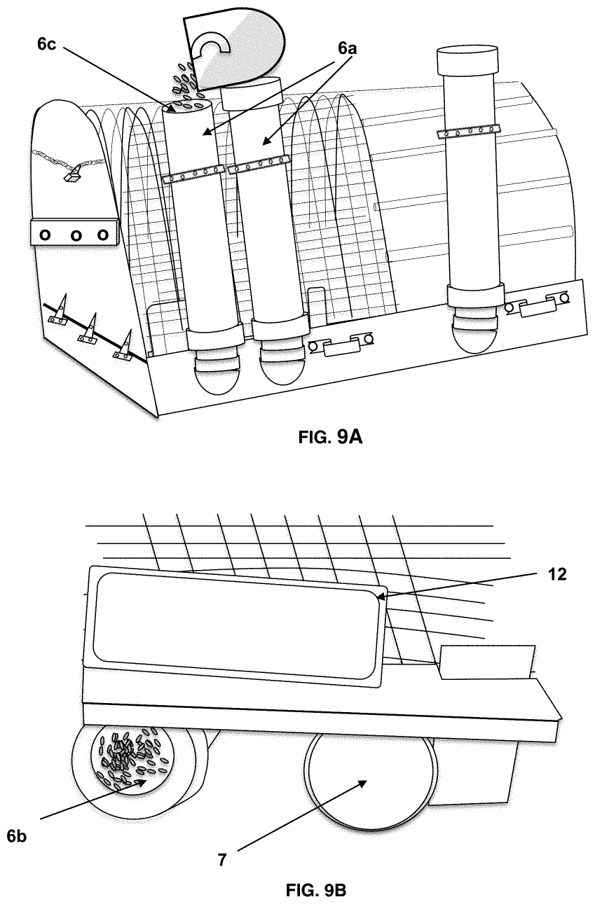

FIG. 9A shows food being stocked within the feed reservoir 6a through an open top end 6c. FIG. 9B shows the food within the feed receptacle 6b, accessible to poultry from within the living space.

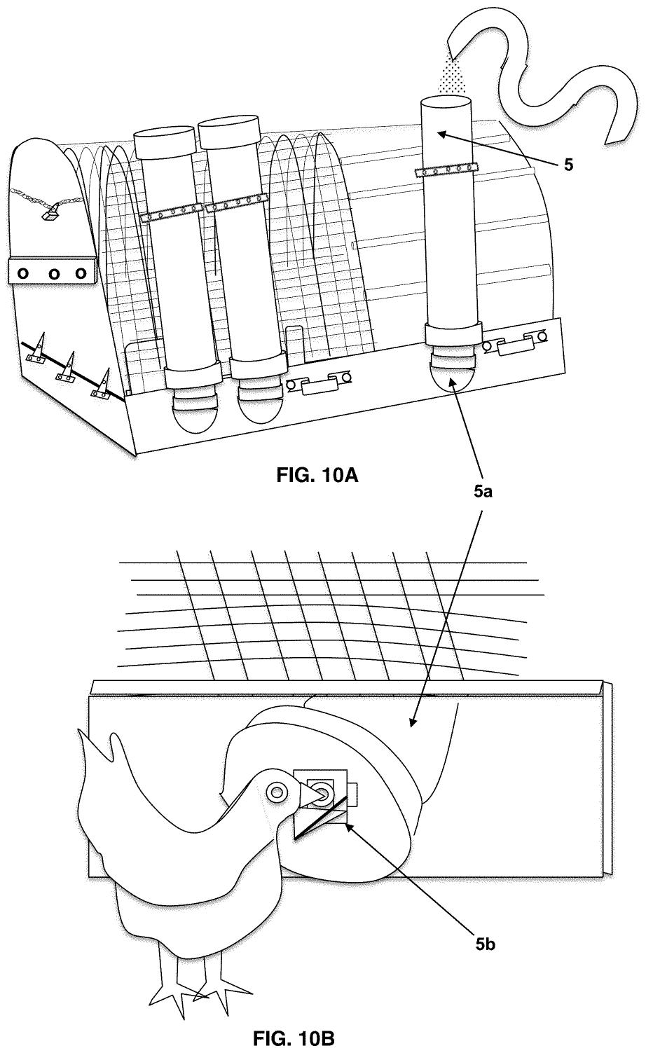

FIG. 10A shows the water reservoir 5 being filled with water. FIG. 10B shows that the water reservoir is attached at the bottom end 5a to the water nipple 5b for the chicken to drink water from within the living space in the coop.

What is claimed is:

1. A portable coop, comprising:
a frame secured to a floor,
a first entry door hingedly attached to the floor at a front end of the frame and comprising at least one nesting box access door hingedly attached on an outer surface thereof;
a second entry door hingedly attached to the floor at a back end of the frame;
at least one nesting box disposed on an inner surface of the first entry door, said nesting box accessible through the at least one nesting box access door;
a waterer assembly attached to an outer surface of the frame;
a plurality of feeder assemblies attached to the outer surface of the frame;
a plurality of feeder troughs attached to an inner surface of the frame; and
at least one perch secured at each end thereof to the inner surface of the frame.

2. The portable coop of claim 1, further comprising a lock and chain assembly disposed on the front end of the frame and on the back end of the frame, said chain securable across the first entry door and the second entry door.

3. The portable coop of claim 1, wherein the frame has a substantially semi-spherical shape.

4. The portable coop of claim 1, wherein the first entry door, the second entry door, the nesting box and the pair of nesting box access doors are made of a weather-resistant wood, a weather-resistant wood composite, or a weather-resistant synthetic composite, or a combination thereof.

5. The portable coop of claim 1, wherein a back half of the frame is made substantially of wire mesh.

6. The portable coop of claim 1, wherein the waterer assembly comprises:
a water reservoir with an open top end and an open bottom end attached to an outer surface of the frame, said open bottom end in fluid connection with an inside surface of the portable coop; and
a water nipple attached to and in fluid connection with the open bottom end of the water reservoir.

7. The portable coop of claim 6, further comprising an end cap removably securable to the open top end of the water reservoir.

8. The portable coop of claim 6, wherein the water reservoir and the water nipple are made of a weather-resistant plastic or a weather-resistant plastic composite, a metal, or a metal alloy, or a combination thereof.

9. The portable coop of claim 1, wherein each of the plurality of feeder assemblies comprises:
a feed reservoir with an open top end and an open bottom end and each attached to an outer surface of the frame, said open bottom ends in fluid connection with an inside of the portable coop; and
a feed receptacle in fluid connection with the open bottom end of the feed reservoir and comprising an end open to the inside of the portable coop.

10. The portable coop of claim 9, further comprising end caps each removably securable to the open top end of the feed reservoir and to the feed receptacle.

11. The portable coop of claim 9, wherein the feed reservoirs, the feed receptacle and the feare made of a weather-resistant plastic or a weather-resistant plastic composite, a metal, or a metal alloy, or a combination thereof.

12. The portable coop of claim 1, wherein the feeder troughs are made of a weather-resistant plastic or a weather-resistant plastic composite, a metal, or a metal alloy, or a combination thereof.

13. The portable coop of claim 1, wherein the perch is made from weather-resistant wood, a weather-resistant wood composite, a weather-resistant synthetic composite, weather-resistant plastic, a weather-resistant plastic composite, a metal, or a metal alloy, or a combination of any of these materials

14. A portable coop comprising:
a substantially semispherical frame attached to a floor and enclosing a living space for poultry that has:
a first entry door attached to the floor at a front end of the portable coop;
at least one nesting box access door disposed on an outer surface of the first entry door;
a second entry door attached to the floor at a back end of the portable coop; and
a lock and chain assembly disposed on each of the front end and the back end of the frame, said chain securable across the first entry door and the second entry door;
at least one nesting box attached to the inner surface of the first entry door and accessible through the at least one nesting box access door;
a waterer assembly attached to an outer surface of the frame and comprising:
a water reservoir with an open top end and an open bottom end, said open bottom end in fluid connection with an inside surface of the portable coop;
a water nipple in fluid connection with the open bottom end; and
an end cap removably securable to the open top end of the water reservoir;
a plurality of feeder assemblies attached to an outer surface, each comprising:
a feed reservoir with an open top end and an open bottom end, said open bottom end in fluid connection with the inside surface of the portable coop;
a feed receptacle in fluid connection with the open bottom end of the feed reservoir and comprising an end open to the inside of the portable coop; and
end caps each removably securable to the open top end of the feed reservoir and to the feed receptacle;
a plurality of feeder troughs disposed on the inner surface of the frame; and
at least one perch secured at each end on the inner surface of the frame.

15. The portable coop of claim 14, wherein the frame has a substantially semi-spherical shape.

16. The portable coop of claim 14, wherein the first entry door, second entry door, nesting box, nesting box access door are of a weather-resistant wood, a weather-resistant wood composite, or a weather-resistant synthetic composite or a combination thereof.

17. The portable coop of claim 14, wherein the frame is made of wood, wood composite or wire mesh or a combination thereof.

18. The portable coop of claim 14, wherein the water reservoir, the water nipple, the feed reservoir and the feed receptacle and the feeder troughs are made of a weather-resistant plastic or a weather-resistant plastic composite, a metal, or a metal alloy, or a combination thereof.

19. The portable coop of claim 14, wherein the perch is made from weather-resistant wood, a weather-resistant wood composite, a weather-resistant synthetic composite, weather-resistant plastic, a weather-resistant plastic composite, a metal, or a metal alloy, or a combination of any of these materials.

20. The portable coop of claim 14 wherein the frame has a length from about 4 feet to about 12 feet and a width from about 4 feet to about 8 feet at the floor.
